(19) United States
(12) Patent Application Publication
(10) Pub. No.: US 2007/0166640 A1
(43) Pub. Date: Jul. 19, 2007

(54) Defect reduction in immersion lithography

(76) Inventor: Yayi Wei, Altamont, NY (US)

Correspondence Address: SLATER & MATSIL LLP, 17950 PRESTON ROAD, SUITE 1000, DALLAS, TX, 75252, US

(21) Appl. No.: 11/334,850

(22) Filed: Jan. 19, 2006

(51) Int. Cl. G03C 1/00

(52) U.S. Cl. 430/270.1

(57) ABSTRACT

An embodiment of the invention provides a method for forming a semiconductor device. A method comprises forming a resist on a substrate. A photoacid generator (PAG) is dispersed homogeneously in the resist. The method includes concentrating the PAG near a surface of the resist by evaporating a solvent from the resist. In an embodiment, the concentrating includes heating the resist to a first temperature. Embodiments include forming a topcoat layer on the resist after concentrating the PAG. An embodiment includes exposing the photoresist layer to a level of radiation suitable for generating a photoacid within the photoresist layer. Other embodiments include heating the exposed photoresist layer to a second temperature, the second temperature sufficient to deprotect the photoresist layer

### TECHNICAL FIELD

This invention relates generally to lithography in the field of integrated circuit manufacture, and more particularly to a method of improving defectivity of chemically amplified resists.

### BACKGROUND

Lithography is widely used in the manufacture of integrated circuits. In lithography, and more particularly photolithography, a photoresist layer is formed on a semiconductor substrate. The photoresist is then exposed in certain areas to actinic radiation. The areas that are irradiated are defined by a mask that is projected onto the photoresist by a lens system. The mask contains a pattern of transparent and opaque areas. The mask is exposed to actinic radiation, such as ultraviolet light (UV), which is transmitted through the transparent areas of the mask to cause a chemical reaction in corresponding regions of the photoresist.

In a negative type photoresist the radiation impacted areas of the photoresist become insoluble in a developing solvent. For example, the radiation can initiate cross-linking, chain growth, photocondensation, or other such reaction to cause a chemical change in the photoresist. In a positive type photoresist the irradiated areas become more soluble in a developing solvent. For example, the radiation can cause photodegradation of the photoresist molecular structure.

Advancements in photoresist materials and methods have played a key role in the miniaturization of integrated circuits. Chemically amplified resists are an important class of photoresists for imaging wavelengths at or below 193 nm. Chemically amplified resists typically include four components: a base polymer with protected chemically reactive, hydrophobic groups; a photoacid generator (PAG); a base; and a solvent. Upon exposure to UV or other type of actinic, or activating, radiation, the PAG photodecomposes and generates a proton, H⁺. During a later post-exposure bake (PEB), the H⁺ acts as a catalyst to convert the hydrophobic protected groups on the base polymer into strong hydrophilic groups such as —COOH. This conversion, which is often called deprotection, makes a positive resist soluble in the developer.

Developer soluble topcoats are an important class of materials for 193 nm immersion lithography. The topcoat, which is formed on the resist, serves as a barrier layer between the solvent, typically water, and the resist. The topcoat prevents leaching of resist components into the water, and it prevents penetration of the water into the resist. However, problems are encountered with topcoats, especially with the interface between the topcoat and the resist.

Typically, an intermixing layer is formed at the topcoat/resist interface. The intermixing layer often has a low dissolution rate compared to the topcoat layer, thereby causing spatial variations in topcoat solubility. The intermixing layer has been blamed for generating defects on resist patterns. Defects may include topcoat and/or resist residuals, line broadening, line bridging, blobs, and other defects in the patterned integrated circuit.

In light of such problems, there is a need for improved methods and materials in high-resolution lithography.

### SUMMARY OF THE INVENTION

These and other problems are generally solved or circumvented, and technical advantages are generally achieved, by preferred embodiments of the present invention that provide a method for reducing resist defects in immersion lithography.

A preferred embodiment of the invention provides a method for forming a semiconductor device. A method comprises forming a resist on a substrate. A photoacid generator (PAG) is dispersed homogeneously in the resist. Embodiments include concentrating the PAG near a surface of the resist by evaporating a solvent from the resist. A topcoat layer is formed on the resist after concentrating the PAG.

Note that although the term layer is used throughout the specification and in the claims, the resulting features formed using the layer should not be interpreted together as only a continuous or uninterrupted feature. As will be clear from reading the specification, the semiconductor layer will be separated into distinct and isolated features (e.g., active regions or device fabrication regions), some or all of which comprise portions of the semiconductor layer.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a cross sectional view a of chemically amplified resist according to an embodiment of the invention;

FIG. 2 is a cross sectional view illustrating a pre-exposure bake (PAB) of a resist according to an embodiment of the invention;

FIG. 3 is a plot of photoacid concentration vs. depth from resist surface after PAB;

FIG. 4 is a cross sectional view illustrating topcoat forming according to an embodiment of the invention;

FIG. 5 is a cross sectional view illustrating resist exposure according to an embodiment of the invention;

FIG. 6 is a cross sectional view illustrating a post exposure bake according to an embodiment of the invention; and

FIG. 7 is a cross sectional view illustrating a patterned resist according to an embodiment of the invention.

Corresponding numerals and symbols in the different figures generally refer to corresponding parts unless otherwise indicated. The figures are drawn to clearly illustrate the relevant aspects of the preferred embodiments and are not necessarily drawn to scale. To more clearly illustrate certain embodiments, a letter indicating variations of the same structure, material, or process step may follow a figure number.

### DETAILED DESCRIPTION OF ILLUSTRATIVE EMBODIMENTS

The making and using of preferred embodiments are discussed in detail below. It should be appreciated, however, that the present invention provides many applicable inventive concepts that may be embodied in a wide variety of specific contexts.

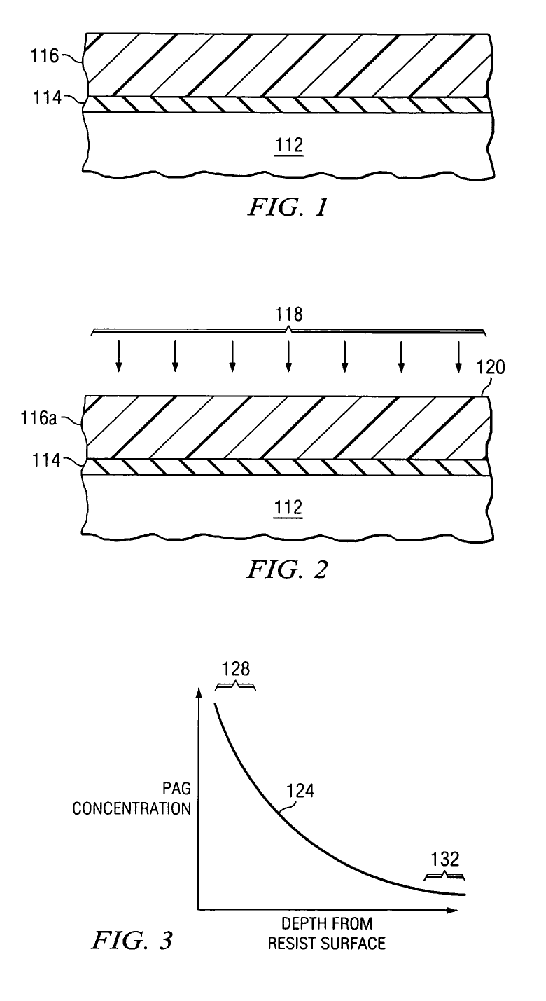

Referring now to FIG. 1, there is shown a cross sectional view of a semiconductor structure comprising a semiconductor body 112 upon which has been deposited an anti-reflection coating (ARC) 114, and upon this ARC 114 has been deposited a resist layer 116. It is desired to expose selected areas of the resist layer 116 to a pattern of light that will result in these selected areas of the resist layer 116 being removed from the semiconductor structure when the resist layer 116 is developed.

Semiconductor body 112 preferably comprises a silicon substrate, such as a bulk single crystal wafer, or a silicon layer overlying another layer, e.g., a silicon-on-insulator (SOI) substrate or an epitaxially grown layer. In other embodiments, the semiconductor body may include or consist of other semiconductors such as silicon germanium, gallium arsenide, and others.

The ARC 114 may comprise chrome oxynitride, titanium nitride, silicon nitride, or molybdenum silicide, for example. In preferred embodiments, the resist 116 may be a positive or negative photoresist. With a negative photoresist, the exposed areas become less soluble in a developing solvent, for example by cross-linking of the polymer chains of the base resin. With positive photoresists, the exposed areas become more soluble, for example by degradation or the formation of more soluble groups on the molecular chain. Aromatic groups tend to block transmission of UV radiation, especially at shorter wavelengths. Hence, for use with 200 nm to 250 nm UV radiation the base resin should have a reduced amount of aromatic groups ranging from 0% to about 20% by weight of aromatic content. For use with UV radiation having wavelengths of less than 200 nm, the base resin in the photoresist should contain substantially no aromatic groups.

In preferred embodiments, the resist 116 includes a photoacid generator (PAG), which generates an acid upon suitable exposure to radiation. Typically, the PAG is tailored to the exposure wavelength. For example, a 248 nm photoresist includes a PAG that strongly absorbs KrF excimer laser light. A 193 nm photoresist strongly absorbs ArF excimer laser light. In addition to the PAG, the photoresist includes a base resin that undergoes an acid catalyzed chemical reaction. Such photoresists are well known in the art.

In preferred embodiments, base resin includes a reactive component, in addition to the PAG, that is initially made non-reactive using a protecting group. Chemical protecting groups are commonly known in the chemical arts, particularly in organic synthesis. Exposing the photoresist removes the protecting group and causes the photoresist to chemically react. With a chemically amplified photoresist, the chemical reaction is catalyzed by a photoacid generated by the PAG.

Suitable chemically amplified photoresists include functional groups (or active sites) such as hydroxyl (——OH), carboxyl (——COOH), mercapto (——SH), amino (——NH₂), alkylamino (——NHR), imino (——NH——), formyl (——CHO), sulfo (——SO₃H), an phosphono (——P(O) (OH)₂). Hydroxyl and carboxyl are preferred. The active sites can be protected with a suitable blocking agent having protecting groups. Suitable protecting groups include, e.g., benzyloxycarbonyl, trifluoroacetyl, benzyl ester, t-butyl ester, N-hydroxysuccinimide ester, and the like. A preferred blocking agent for the includes tert-butoxycarbonyl groups (t-BOC).

By way of example, a suitable chemically amplified photoresist resin, or more conveniently, a base resin, for the positive or negative photoresist may be selected from polyhydroxystyrene, polymethylmethacrylate, poly(t-butyl)methacrylate, polyvinyl alcohol, polyvinylphenol, polynorbonene, poly(p-formyl)oxystyrene, poly(t-butoxycarbonyloxystyrene), polyvinylpyrrolidone, polymethylisoprenylketone, phenolformaldehyde polymers, melamine-formaldehyde polymers, and copolymers, blends and derivatives of these resins.

Suitable photoacid generators include, for example, diaryliodonium salts, triarylsulfonium salts, and substituted aryldiazonium salts, the salts having counterions such as tetrafluoborate, hexafluoroantimonate, hexafluoroarsenate and hexafluorophosphate. Other photoacid generators are halomethanes, trichlorotriazine, a-naphthol, nitrobenzaldehyde and polyvinylchloride.

The resist 116 may include additional substances used in conventional resist formulations. These additional substances may include, for example, additional polymers, sensitizers, crosslinking agents, speed enhancers, flexibility enhancers, adhesion enhancers, heat resistance enhancers, and surfactants. Such components are well known in the art. Examples of sensitizers are diazoquinones such as naphthoquinone-(1,2)-diazide sulfonic acid esters, and particularly the 5-sulfonic acid ester of diazonaphthoquinone. Formulated photoresists and photoresist components are widely available from commercial suppliers.

In preferred embodiments 248 nm base resins include phenolic-containing resins, e.g., poly(hydroxystyrene) polymers. Preferred 193 nm base resins include poly(meth)acrylates; copolymers of cyclic olefins and maleic anhydride; cyclic olefin addition polymers; cyclic olefin-maleic anhydride-(meth)acrylate hybrid polymers and cyclic olefin-(meth)acrylate polymers.

The resist 116 applied to a substrate body 112, which may comprise a silicon wafer, in a conventional manner. Usually, the photoresist solution is applied to a silicon wafer, which is then spun to distribute the photoresist in the form of an even layer over the wafer. The preferred thickness of the resist layer 116 is preferably no more than about 1 micron, preferably no more than about 0.8 microns, more preferably no more than about 0.5 microns, and most preferably no more than about 0.3 microns.

Turning now to FIG. 2, the resist 116 is then heated in a pre-exposure baking (PAB) 118 step. Conventional pre-exposure baking (PAB) steps are known to those skilled in the art. Conventional PAB may include mildly heating a resist to about 100° C. to drive off the solvent. Preferred embodiments of the invention, however, include a high-temperature PAB 118 process.

The pre-exposure bake 118 of preferred embodiments creates photoacid generators, thereby forming a PAG-containing resist 116a. By using a high temperature PAB 118, a larger amount of resist solvent evaporates from the surface 120 of the resist 116a. This increases the local PAG concentration near the resist surface 120. FIG. 3 schematically illustrates a plot 124 the PAG concentration versus depth from the resist surface 120.

In one example, a methacrylate resist AR1682J manufactured by JSR (Japanese Synthetic Rubber) has a recommended PAB of 110° C. for 60 seconds. Applicants found reduced defectivity by using a PAB between about 120° C. and about 130° C. for about 90 seconds.

An effect of the high temperature PAB 118 is to evaporate solvent from the resist surface, thereby forming a concentrated PAG region 128 near the resist surface. Another effect is to form a PAG depleted region 132 at the opposite side of the resist (i.e., the side near the ARC layer 114, FIG. 2.) Forming a concentrated PAG region 128 near the resist surface advantageously generates more photoacid within this region after exposure.

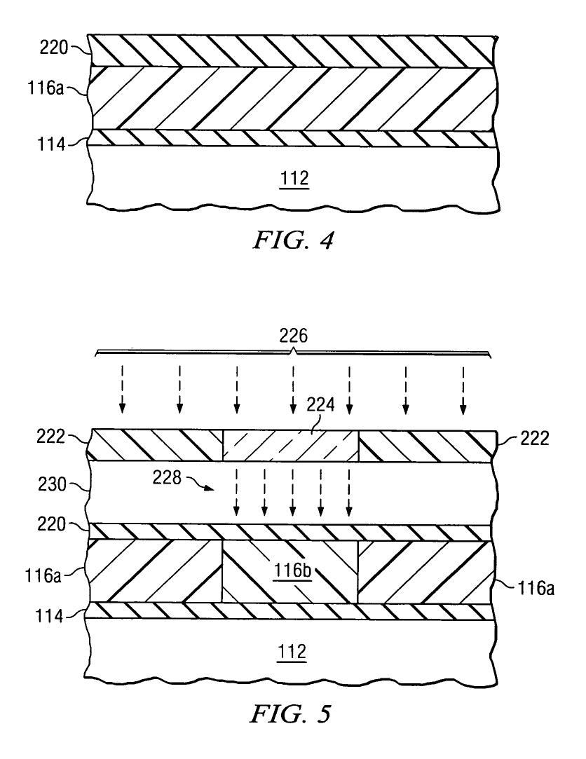

Turning now to FIG. 4, there is the structure of FIG. 2 after forming a topcoat layer 220 over the resist layer 116a. Preferably, the topcoat layer is formed after performing the pre-exposure bake. The topcoat 220 may comprise the same material used to form the ARC 114. Preferably, the topcoat 220 is matched with the refractive index of the resist 116. In preferred embodiments of the invention, the refractive index of protective topcoat layer 220 is approximately equal to the square root of the refractive index of the chemically amplified resist layer 116a multiplied by the refractive index of the immersion medium.

Turning now to FIG. 5, the resist layer 116a is exposed to patterned light 228. A patterned opaque mask 222 with a transparent portion 224 is illuminated by non-patterned light 226, with patterned light 228 being transmitted through the transparent portion 224 and impinging upon resist 116a. In keeping with immersion lithography, the patterned light 228 is transmitted through an immersion medium 230, preferably water.

The patterned light 228 preferably comprises short wavelength UV actinic radiation having a wavelength of about 248 nm and more preferably far UV having a wavelength less than about 200 nm. A typical energy dose may be about 10 to about 200 mJ/cm². The patterned light 228 results an exposed portion of the resist 116b, which is dissolved and removed when subjected to a photoresist developer solution.

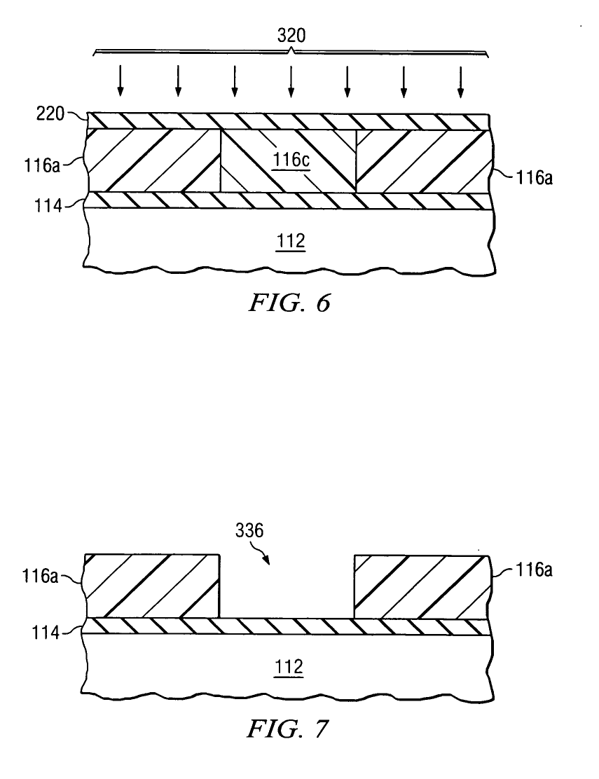

Turning now to FIG. 6, preferred embodiments of the invention include a post exposure bake (PEB) 320. The PEB performs the deprotection reaction commonly used for chemically amplified resists, thereby forming a developed resist 116c.

As is known in the art, the deprotection step exposes active sites of the base resin for reacting with the developing solution. The deprotection typically includes a heat treatment, which amplifies the acid generated during the exposure. The acid, in turn, deprotects the base resin during the heat treatment by exposing the active groups (e.g. hydroxyl, carboxyl, etc.). The exposed active groups thus become available for reaction. The heat activation that achieves deprotection is conducted at a temperature 100° C. and 150° C. for between about 1 minute to about 5 minutes.

As described above, the pre-exposure bake of embodiments of the invention concentrates the photoacid generator near the surface of the resist. Therefore, more photoacid is generated within this region, thereby enhancing the solubility of this region in development. This prevents the formation of an intermixing region between the resist layer 116 and the topcoat 220 as is typically found in conventional exposure/development methods. With little or no intermixing region formed, a sharp boundary in chemical properties is maintained between the two adjacent layers and the defects associated with conventional methods is greatly reduced or eliminated.

Therefore, in preferred embodiments of the invention, the photoacid generator has a maximum concentration proximate the topcoat. A preferred method further comprises generating a photoacid in the resist after forming the topcoat layer. Generating the photoacid comprises heating the resist for more than about 1 minute at between about 100° C. and about 150° C. Because the PAG is distributed according to FIG. 3, the photoacid has a maximum in concentration proximate the topcoat.

FIG. 7 shows the semiconductor structure after the PEB and after development of the resist layer and removal of the topcoat layer. This results in a portion of resist 116 being removed and an opening 336 in the remaining resist layer 116a.

Preferred embodiments of the invention provide an immersion lithography method for forming an integrated circuit feature such as a contact hole or via having a critical dimension. A method comprises forming a photoresist layer on a substrate, wherein the photoresist layer includes a photoacid generator (PAG). The photoresist layer is heated to a first temperature. Preferably, heating the resist to the first temperature, or a baking at the first temperature, is not sufficient to cause substantial chemical amplification of the photoacid. Embodiments include forming a topcoat on the photoresist layer after heating the photoresist layer to a first temperature. Embodiments include exposing the photoresist layer to a level of radiation suitable for generating a photoacid within the photoresist layer. The exposed resist is heated to a second temperature. Preferably, the second temperature sufficient to deprotect the photoresist layer. In an embodiment, the integrated circuit feature comprises a contact hole or a via with a dimension less than about 100 nm.

Other embodiments provide a method of patterning a resist. The method comprises forming a resist on a substrate, wherein the resist comprises a photoacid generator. Preferred embodiments include concentrating the PAG at a surface of the resist by baking the resist at a first temperature, and forming a topcoat layer on the resist after concentrating the PAG. The method may further include generating a photoacid in the resist after forming the topcoat layer and reacting the resist with the photoacid. Embodiments may include baking the resist at a second temperature. Preferably, the second temperature greater than the first temperature.

Although the present invention and its advantages have been described in detail, it should be understood that various changes, substitutions and alterations may be made herein without departing from the spirit and scope of the invention as defined by the appended claims. It will also be readily understood by those skilled in the art that materials and methods may be varied while remaining within the scope of the present invention.

It is also appreciated that the present invention provides many applicable inventive concepts other than the specific contexts used to illustrate preferred embodiments. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for forming a semiconductor device, the method comprising:
forming a resist on a substrate, the resist comprising a photoacid generator (PAG) dispersed substantially homogeneously in the resist;
concentrating the PAG near a surface of the resist by evaporating a solvent from the resist; and
forming a topcoat layer on the resist after concentrating the PAG.

2. The method of claim 1, wherein the resist comprises a methacrylate resist.

3. The method of claim 2, wherein concentrating the resist comprises heating the resist to between about 120° C. and about 130° C. for about 90 seconds.

4. The method of claim 1, wherein the topcoat layer comprises a material selected from the group consisting essentially of chrome oxynitride, titanium nitride, silicon nitride, molybdenum silicide, and combinations thereof.

5. The method of claim 1, wherein the photoresist is selected from the group consisting essentially of resists poly(meth)acrylates, copolymers of cyclic olefins and maleic anhydride, cyclic olefin addition polymers, cyclic olefin-maleic anhydride-(meth)acrylate hybrid polymers, cyclic olefin-(meth)acrylate polymers, and combinations thereof.

6. The method of claim 1, wherein the photoacid generator has a maximum in concentration proximate the topcoat.

7. The method of claim 1, further comprising generating a photoacid in the resist after forming the topcoat layer.

8. The method of claim 7, wherein generating the photoacid comprises heating the resist for more than about 1 minute at between about 100° C. and about 150° C.

9. The method of claim 7, wherein the photoacid has a maximum in concentration proximate the topcoat.

10. An immersion lithography method for forming an integrated circuit feature having a critical dimension, the method comprising:
forming a photoresist layer on a substrate, wherein the photoresist layer includes a photoacid generator (PAG);
heating the photoresist layer to a first temperature;
forming a topcoat on the photoresist layer;
exposing the photoresist layer to a level of radiation suitable for generating a photoacid within the photoresist layer; and
heating the exposed photoresist layer to a second temperature, the second temperature sufficient to deprotect the photoresist layer.

11. The method of claim 10, wherein the resist comprises a methacrylate resist.

12. The method of claim 10, wherein baking the resist at the first temperature comprises baking for less than about 90 seconds at between about 120° C. and about 130° C.

13. The method of claim 10, wherein the first temperature is below the glass transition temperature of the resist, and the second temperature is greater than the first temperature.

14. The method of claim 10, wherein heating the photoresist layer to a first temperature concentrates the PAG in a surface region of the resist.

15. The method of claim 10, the radiation has a wavelength less than about 193 nm.

16. The method of claim 15, wherein the level of radiation suitable for generating a photoacid comprises a dosage between about 10 mJ/cm² to about 200 mJ/cm².

17. The method of claim 10, wherein the integrated circuit feature comprises a contact hole or a via with a dimension less than about 100 nm.

18. A method of patterning a resist, the method comprising:
forming a resist on a substrate, wherein the resist comprises a photoacid generator (PAG);
concentrating the PAG at a surface of the resist by baking the resist at a first temperature;
forming a topcoat layer on the resist after concentrating the PAG;
generating a photoacid in the resist; and
reacting the resist with the photoacid.

19. The method of claim 18, wherein the resist comprises a methacrylate resist.

20. The method of claim 19, wherein baking the resist at the first temperature comprises baking for less than about 90 seconds at between about 120° C. and about 130° C.
